(19) United States
(12) Patent Application Publication
(10) Pub. No.: US 2004/0259585 A1
(43) Pub. Date: Dec. 23, 2004

(54) Wireless device having dual bus archeticure for interfacing with cellular signals and short-range radio signals

(76) Inventors: Avi Yitzchak, Bnei Zion (IL); Peter Fornell, Lake Oswego, OR (US); Amit Haller, Belmont, CA (US); Ziv Haparnas, Tel Aviv (IL)

Correspondence Address: KIRK J. DENIRO, ESQ., VIERRA, MAGEN, MARCUS, HARMON & DENIRO, LLP, 685 MARKET STREET, SUITE 540, SAN FRANCISCO, CA, 94105, US

(21) Appl. No.: 10/454,967

(22) Filed: Jun. 4, 2003

(51) Int. Cl. H04M 3/00

(52) U.S. Cl. 455/550.1; 455/552.1

(57) ABSTRACT

A wireless device having dual bus architecture for interfacing with cellular signals and short-range radio signals is provided in an embodiment of the present invention. A first bus couples a first processor to a first transceiver capable to transmit and receive cellular signals. A second bus couples a second processor to a second transceiver capable to transmit and receive short-range radio signals. A third bus is coupled to the first processor and the second processor for transferring multiplexed commands and data. A fourth bus is coupled to the first processor and the second processor for transferring an audio signal, such as a human voice. In an embodiment of the present invention, each processor has a universal a synchronous receiver-transmitter (“UART”) coupled to the third bus, such as a RS-232 bus, and the fourth bus is a pulse code modulation (“PCM”) bus. A first memory device is coupled to the second bus and stores a microrouter software component for transferring an Internet protocol (“IP”) packet.

### FIELD OF THE INVENTION

This invention relates generally to a wireless device.

### BACKGROUND OF THE INVENTION

Complex wireless devices, such as cellular telephones, have a large number of electronic and software components that must operate properly and communicate in a timely manner in order for the device to function. For example, particular electronic components are required to receive and transmit cellular signals; while other software components are responsible for displaying data received from the cellular signals. In order to bring a wireless device to market, a significant amount of time is required to integrate and test the multiple electronic and software components.

Similarly, when a manufacturer or distributor is debugging or testing a user's device, a significant amount of time is required for a repairperson to diagnose and repair the complex electronic device. If test and repair procedures can be simplified, a repair facility can save significant time and resources.

Therefore, it is desirable to provide a wireless device that allows for reducing the amount of time required to bring the device to market as well as test and repair the device.

### SUMMARY OF THE INVENTION

A wireless device having dual bus architecture for interfacing with cellular signals and short-range radio signals is provided in an embodiment of the present invention. A first bus couples a first processor to a first transceiver capable to transmit and receive cellular signals. A second bus couples a second processor to a second transceiver capable to transmit and receive short-range radio signals. A third bus is coupled to the first processor and the second processor for transferring multiplexed commands and data. A fourth bus is coupled to the first processor and the second processor for transferring an audio signal, such as a human voice. In an embodiment of the present invention, each processor has a universal a synchronous receiver-transmitter (“UART”) coupled to the third bus, such as a RS-232 bus, and the fourth bus is a pulse code modulation (“PCM”) bus. A first memory device is coupled to the second bus and stores a microrouter software component for transferring an internet protocol (“IP”) packet in the data.

Other aspects and advantages of the present invention can be seen upon review of the figures, the detailed description, and the claims that follow.

### BRIEF DESCRIPTION OF THE FIGURES

FIGS. 1-2 illustrate a wireless device and terminal having dual bus architecture according to an embodiment of the present invention.

FIG. 3 illustrates a system including a wireless device and terminal shown in FIG. 1 according to an embodiment of the present invention.

FIG. 4 illustrates thin terminals and a wireless device according to an embodiment of the present invention.

FIGS. 5a-b illustrate software architecture for a wireless device according to an embodiment of the present invention.

FIGS. 5c-d illustrate software architecture for a terminal according to an embodiment of the present invention. FIG. 6 illustrates signals generated on respective buses of the wireless device shown in FIG. 1 according to an embodiment of the present invention.

FIG. 7 illustrates a microrouter used in a wireless device shown in FIG. 1 and in FIG. 5 according to an embodiment of the present invention.

FIG. 8 is a flowchart of a method for multiplexing commands and data on a bus according to embodiments of the present invention.

### DETAILED DESCRIPTION

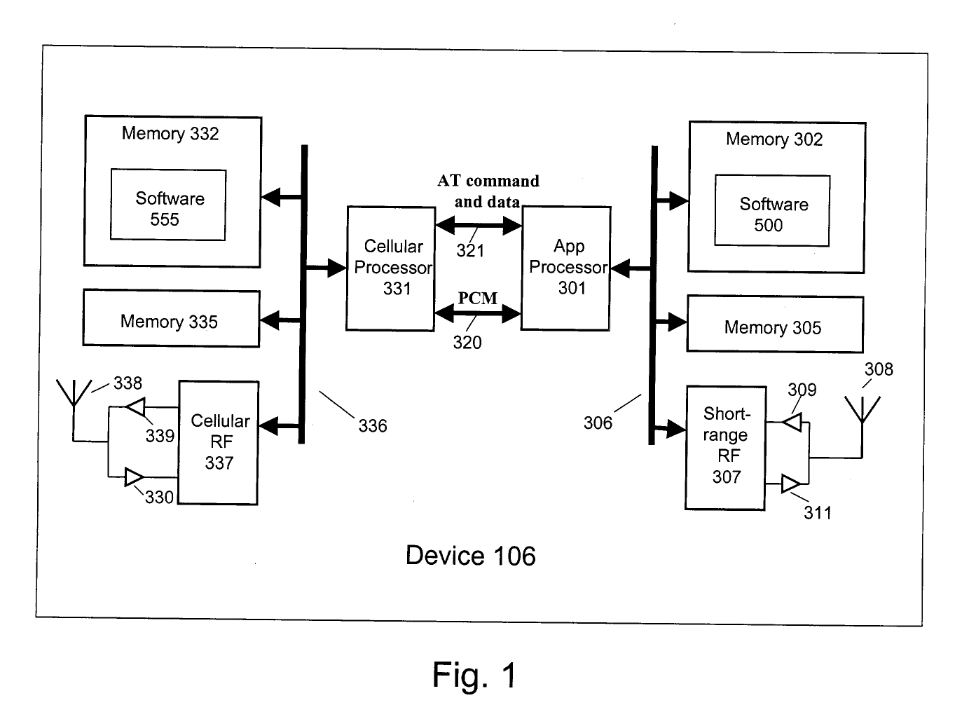

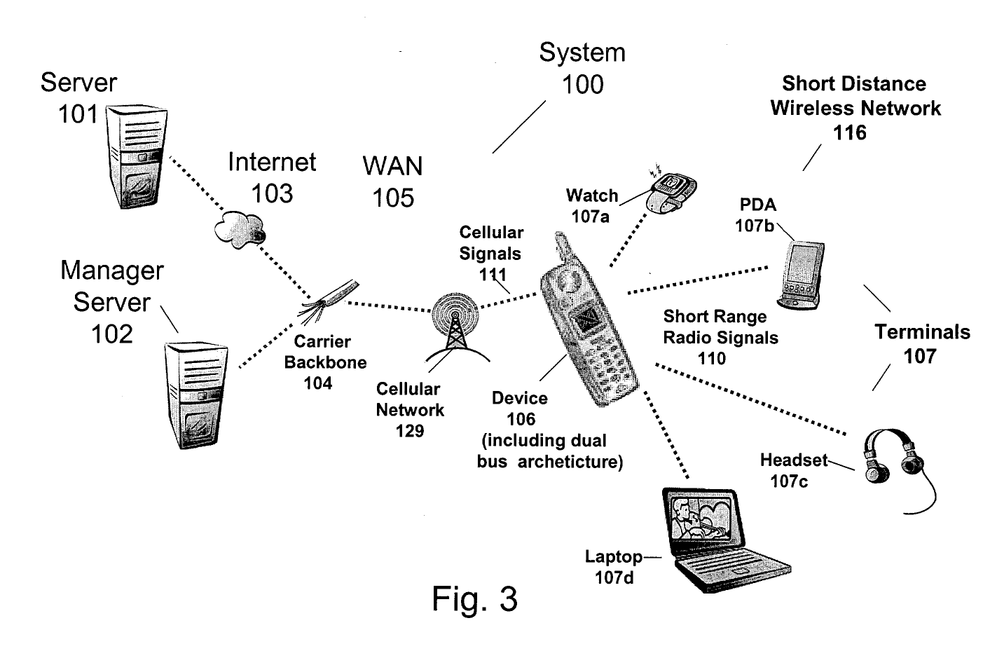

FIG. 1 illustrates dual bus architecture of a device 106 that communicates with a cellular network 129 and short-distance wireless network 116 as shown in FIG. 3. In an embodiment of the present invention, device 106 is a cellular handset or telephone. In an alternate embodiment of the present invention, device 106 is a cellular enabled personal digital assistant (“PDA”), wireless modem and/or wireless laptop computer or an equivalent thereof.

Device 106 includes application (“App”) processor 301 controlling bus 306 and cellular processor 331 controlling bus 336. In an embodiment of the present invention, processors 301 and 331 generate control signals for controlling the communication of components on the respective buses. In embodiments of the present invention, buses 306 and 336 are either 8, 16 or 32 bit buses. In an embodiment of the present invention, buses 306 and 336 include address and data lines. Two buses are used in order to decrease the testing and integration time necessary to provide device 106 to the public. Similarly, two buses are used in order to allow repairpersons to easily test and repair device 106. For example, if device 106 is not transmitting a short-range radio signal, a repairperson can use test procedures focused on electronic components coupled to bus 306.

A Bluetooth™ Radio Frequency (“RF”) or short-range RF circuit 307 is coupled to bus 306. Short-range RF circuit 307 is responsible for providing information from short-range radio signals 110, as seen in FIG. 3, on bus 306.

Likewise, short-range RF circuit 307 is responsible for generating short-range radio signals 110 responsive to information on bus 306.

Short-range RF circuit 307 is coupled to receiver 309 and transmitter 311, collectively known as a transceiver. In embodiments of the present invention, device 106 includes either a 2.4 or 5.7 GHZ transceiver. In an embodiment of the present invention, RF circuit 307 includes analog circuits such as power amplifiers and oscillators. A short-range radio antenna 308 is coupled to receiver 309 and transmitter 311, to receive and transmit short-range radio signals 110.

Memories 302 and 305 are coupled to bus 306 in an embodiment of the present invention. Memory 302 stores software 500 including router software component 404, application (“App”) software component 420 and short-range radio baseband protocol stack software component 501 as described below. For example, App software component 420 is a calendar software application. In an embodiment of the present invention, memory 302 is a memory device selected from the group consisting of FLASH or electrically erasable programmable read-only memory (“EEPROM”), electrically programmable read-only memory (“EPROM”), read-only memory (“ROM”) and an equivalent thereof. In an embodiment of the present invention, memory 305 is a memory device selected from the group consisting of static random access memory (“SRAM”), synchronous dynamic random access memory (“SDRAM”), dynamic random access memory (“DRAM”) and an equivalent thereof. In an alternate embodiment of the present invention, memories 302 and 305 are combined on an integrated circuit formed on a semiconductor substrate having a package. In still a further embodiment of the present invention, either memory 302 or memory 305 is included in App processor 301.

A cellular Radio Frequency (“RF”) circuit 337 is coupled to bus 336. Cellular RF circuit 337 is responsible for providing information from cellular signals 111, as seen in FIG. 3, on bus 336. Likewise, cellular RF circuit 337 is responsible for generating cellular signals 111, such as Global System for Mobile communications (“GSM”) signals, responsive to information on bus 336. In an embodiment of the present invention, cellular signals 111 are transmitted using a protocol, such as a GSM protocol. In alternate embodiments, a Code Division Multiple Access (“CDMA”), CDMA 2000, Universal Mobile Telecommunications System (“UMTS”), Time Division Multiple Access (“TDMA”), General Packet Radio Service (“GPRS”) protocol or an equivalent is used. In a preferred embodiment, a GSM 07.10 Multiplexing protocol is used.

Cellular RF circuit 337 is coupled to receiver 330 and transmitter 339, collectively known as a transceiver. In an embodiment of the present invention, cellular circuit 337 includes analog circuits such as power amplifiers and oscillators. A cellular antenna 338 is coupled to receiver 330 and transmitter 339, to receive and transmit cellular signals 111.

Memories 332 and 335 are coupled to bus 336 in an embodiment of the present invention. Memory 332 stores a software 555 including cellular baseband protocol stack software component 556 for transmitting and receiving cellular signals. In an embodiment of the present invention, memory 332 is a memory device selected from the group consisting of FLASH or EEPROM, EPROM, ROM or an equivalent thereof. In an embodiment of the present invention, memory 335 is a memory device selected from the group consisting of SRAM, SDRAM, DRAM and an equivalent thereof. In an alternate embodiment of the present invention, memories 332 and 335 are combined on an integrated circuit formed on a semiconductor substrate having a package. In still a further embodiment of the present invention, either memory 332 or memory 335 is included in cellular processor 331.

In alternate embodiments, a display, a speaker, a microphone, a keypad and a touchscreen, singly or in combination, is coupled to bus 336. As one of ordinary skill in the art would appreciate, other hardware components can be coupled to bus 336 in alternate embodiments of the present invention.

Processors 331 and 301 communicate by buses 321 and 320. In an embodiment of the present invention, bus 321 carries multiplexed AT commands and data as described below. In an embodiment of the present invention, the data includes an IP packet. In an embodiment of the present invention, each processor 331 and 301 includes a universal a synchronous receiver-transmitter (“UART”) coupled to bus 321, which is a RS-232 bus. In an alternate embodiment of the present invention, bus 321 is a serial peripheral interface (“SPI”) bus, an inter-integrated circuit “1²C ”) bus or dual port random access memory (“DPRAM”).

FIG. 6 illustrates information 580 transferred on bus 321 between App processor 301 and cellular processor 331. In particular, information 580 includes multiplexed AT commands 580a, 580c and data 580b, 580d. AT commands refers to a set of commands, including but not limited to standard AT commands, used for initializing and/or controlling Hayes modems. In an embodiment of the present invention, data 580b and 580d include an IP packet. An example of an AT command is ATD5551212. In alternate embodiments, other types of buses and protocols using different commands are used.

In an embodiment of the present invention, bus 320 carries an analog signal, such as human utterances or voice. In an embodiment of the present invention, bus 320 is a pulse code modulation (“PCM”) bus or a bus that carries PCM signals 590 as shown in FIG. 6.

In an embodiment of the present invention, other power control signals are transferred on lines not shown.

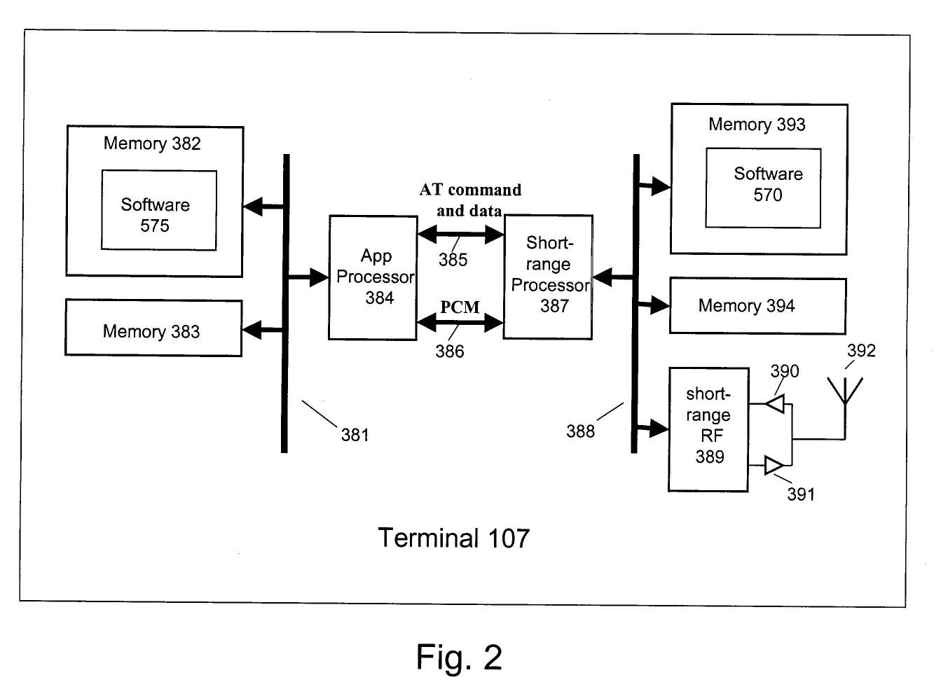

FIG. 2 illustrates a terminal 107, as shown in FIG. 3, for communicating with device 106 and likewise has dual bus architecture. In an embodiment of the present invention, terminal 107 is a messaging terminal. In an alternate embodiment, terminal 107 is a desktop computer, a pager, a pen, a printer, a watch, a thin terminal, a PDA, a headset, a digital camera or an equivalent.

Terminal 107 includes short-range processor 387 controlling bus 388 and App processor 384 controlling bus 381. In an embodiment of the present invention, processors 387 and 388 generate control signals for controlling the communication of components on the respective buses. In embodiments of the present invention, buses 388 and 381 are either 8, 16 or 32 bit buses. In an embodiment of the present invention, buses 381 and 388 include address and data lines. Two buses are used in order to decrease the testing and integration time necessary to provide terminal 107 to the public. Similarly, two buses are used in order to allow repairpersons to easily test and repair terminal 107. For example, if terminal 107 is not transmitting a short-range radio signal, a repairperson can use test procedures focused on electronic components coupled to bus 388.

A Bluetooth™ RF or short-range RF circuit 389 is coupled to bus 388. Short-range RF circuit 389 is responsible for providing information from short-range radio signals 110, as seen in FIG. 3, on bus 388. Likewise, Short-range RF circuit 389 is responsible for generating short-range radio signals 110 responsive to information on bus 388.

Short-range RF circuit 389 is coupled to receiver 390 and transmitter 391, collectively known as a transceiver. In an embodiment of the present invention, short-range RF circuit 389 includes analog circuits such as power amplifiers and oscillators. In embodiments of the present invention, terminal 107 includes either a 2.4 or 5.7 GHZ transceiver. A short-range radio antenna 392 is coupled to receiver 390 and transmitter 391, to receive and transmit short-range radio signals 110.

Memories 393 and 394 are coupled to bus 388 in an embodiment of the present invention. Memory 393 stores software 570 as described below. For example, software 570 includes short-range baseband protocol stack software component 501. In an embodiment of the present invention, memory 388 is a memory device selected from the group consisting of FLASH or EEPROM, EPROM, ROM and an equivalent thereof. In an embodiment of the present invention, memory 394 is a memory device selected from the group consisting of SRAM, SDRAM, DRAM and an equivalent thereof. In an alternate embodiment of the present invention, memories 393 and 394 are combined on an integrated circuit formed on a semiconductor substrate having a package. In still a further embodiment of the present invention, either memory 393 or memory 394 is included in processor 387.

App processor 384 is coupled to memories 382 and 383 by bus 381 in an embodiment of the present invention. Software 575, including an application software component 440 such as a messaging software application component, is stored in memory 382 in an embodiment of the present invention.

In an embodiment of the present invention, memory 382 is a memory device selected from the group consisting of FLASH or EEPROM, EPROM and ROM. In an embodiment of the present invention, memory 383 is a memory device selected from the group consisting of SRAM, SDRAM, DRAM and an equivalent thereof. In an alternate embodiment of the present invention, memories 382 and 383 are combined on an integrated circuit formed on a semiconductor substrate having a package. In still a further embodiment of the present invention, either memory 382 or memory 383 is included in App processor 384.

App processor 384 and short-range processor 387 communicate by way of buses 385 and 386 as described above in regard to buses 321 and 320, respectively. AT commands and data are multiplexed on bus 385 and PCM signals for voices are provided on bus 386. In alternate embodiments, other types of buses and protocols using different commands are used.

FIG. 3 illustrates system 100 according to an embodiment of the present invention. System 100 includes other devices or terminals 107 coupled to wireless device 106. In an embodiment of the present invention, device 106 and one or more terminals 107 communicate to form a short distance wireless network 116. In an embodiment of the present invention, terminals 107 are coupled to device 106 by short-range radio signals 110 to form short distance wireless network 116. In an embodiment of the present invention, some or all of terminals 107 may have wired connections. In an embodiment of the present invention, terminals 107 include a watch 107a, PDA 107b, headset 107c and laptop computer 107d that generate respective output signals. In an alternate embodiment, fewer or more terminals are used in short distance wireless network 116.

In an embodiment of the present invention, a short distance wireless network is a network of processing devices, such as a personal computer or headset, that span a relatively small physical area, wherein at least one device generates and receives a short-range radio signal for communicating with another device in the network. In an embodiment of the present invention, a short-range radio signal can travel between approximately 0 and approximately 1,000 feet. An example of a short distance wireless network includes a network of devices formed by Bluetooth™, HomeRF, 802.11 technologies, or an equivalent, singly or in combination. In an embodiment of the present invention, each processing device in a short distance wireless network has its own processing unit that executes a software component stored on the processing device memory, but also may access data and devices on the short distance wireless network. In an embodiment of the present invention, a wire, and in particular an Ethernet, provides communication between two or more processing devices in a short distance wireless network. In an alternate embodiment, electromagnetic signals provide wireless communication between one or more processing devices in a short distance wireless network. In still another embodiment, both wires and electromagnetic signals provide communication between processing devices in a short distance wireless network.

In an embodiment of the present invention, WAN 105, including cellular network 129, is coupled to device 106. In an embodiment of the present invention, a WAN includes multiple local area networks (“LANs”) and/or short distance wireless networks connected over a relatively large distance. Telephone lines and electromagnetic signals, singly or in combination, couple the LANs and/or short distance wireless networks in a WAN. In an embodiment of the present invention, WAN 105 includes a cellular network 129 generating and receiving cellular signals 111. In an embodiment of the present invention, a cellular network is defined as a communication system dividing a geographic region into sections, called cells. In an analog embodiment of the present invention, the purpose of this division is to make the most use out of a limited number of transmission frequencies. In an analog embodiment of the present invention, each connection, or for example conversation, requires its own dedicated frequency, and the total number of available frequencies is about 1,000. To support more than 1,000 simultaneous conversations, cellular systems allocate a set number of frequencies for each cell. Two cells can use the same frequency for different conversations so long as the cells are not adjacent to each other.

In an embodiment of the present invention, WAN 105 includes an IP public or private network, such as a corporate secured network using a Virtual Private Network (“VPN”).

In an alternate embodiment of the present invention, device 106 is coupled to WAN 105 by an Ethernet, Digital Subscriber Line (“DSL”), or cable modem connection, singly or in combination.

In an embodiment of the present invention, WAN 105 is coupled to a wireless carrier internal network or carrier backbone 104. In an embodiment of the present invention, server 102 is coupled to carrier backbone 104. In an alternate embodiment of the present invention, carrier backbone 104 is coupled to Internet 103. Server 101 is coupled to Internet 103. In an embodiment of the present invention, servers 101 and 102 provide information or services, such as web pages or application software components, to terminals 107 by way of device 106. In an embodiment of the present invention, manager server 102 provides a microrouter 404 and/or network service plug-ins 406a-k to device 106, as described below. Further, manager server 102 monitors applications and terminals in a short distance wireless network 116. In an embodiment of the present invention, terminals 107 share services and communicate by way of device 106.

In an embodiment of the present invention, IP packets are transferred between the components illustrated in FIG. 3. In alternate embodiments of the present invention, other packet types are transferred between the components illustrated in FIG. 3.

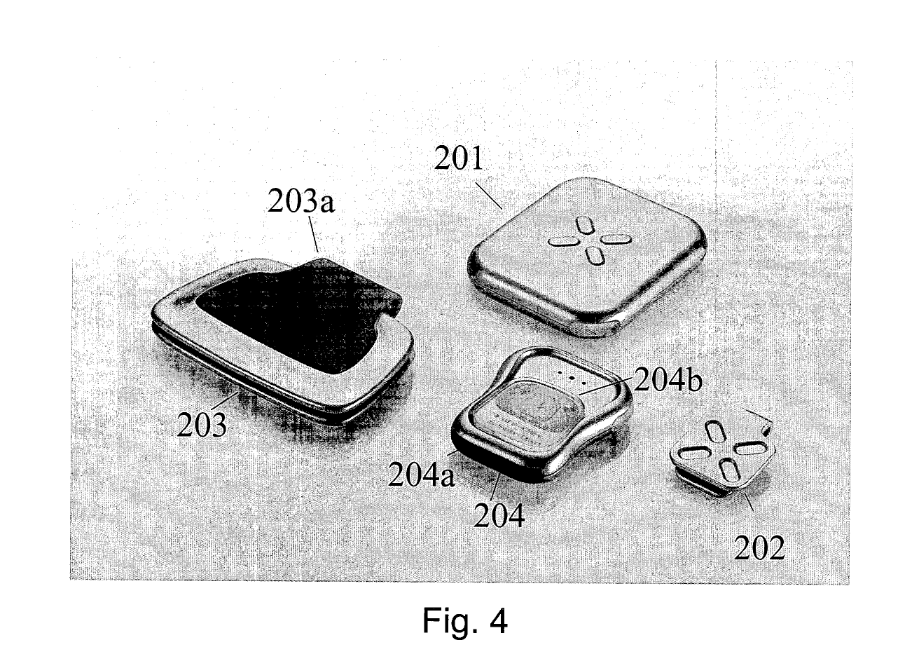

FIG. 4 illustrates embodiments of terminals 107 and device 106. In an embodiment of the present invention, there are two types of terminals: 1) smart terminals and 2) thin terminals. In an alternate embodiment of the present invention, smart terminals execute user logic and applications. Smart terminals have a relatively powerful processing unit, operating system and applications. Their main needs from a short distance wireless network 116 are access to a WAN 105 through TCP/IP and other network services such as storage and execution. For example, a laptop computer 107d and PDA 107b are smart terminals. Thin terminals have a relatively low power processing unit and operating system. They are mainly used as peripherals to an application server in a short distance wireless network 116 and their main task is user interaction, rendering output for a user and providing an application server with a user's input. For example, a watch 107a or messaging terminals can be thin terminals.

FIG. 4 illustrates thin terminals. Voice terminal 204 includes a display 204b and a retractable keypad 204a. Messaging Terminal 203 is illustrated in a closed position with a hinge 203a used to open and close terminal 203. Terminal 203 also includes a miniature QWERTY keyboard and display when opened.

In an embodiment of the present invention, device 201 is a cellular modem and includes a clip 202 for a belt.

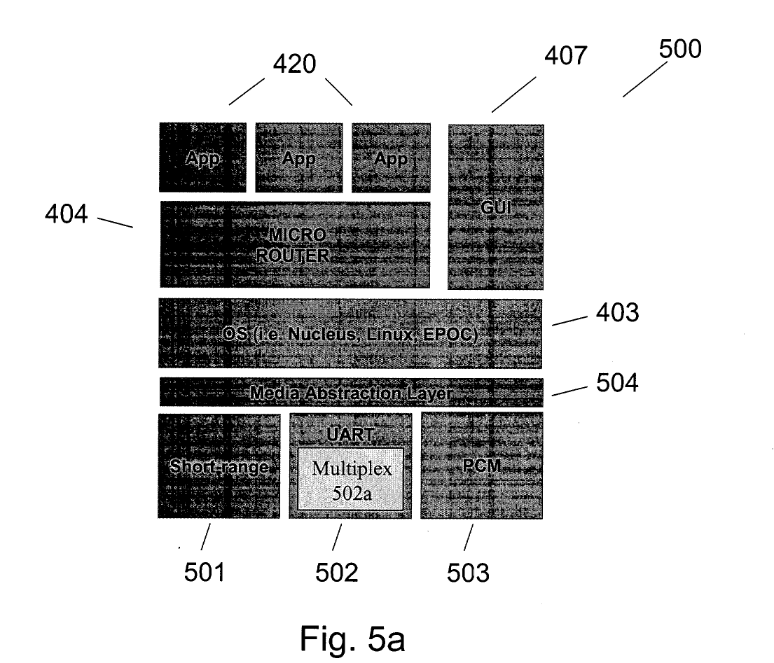

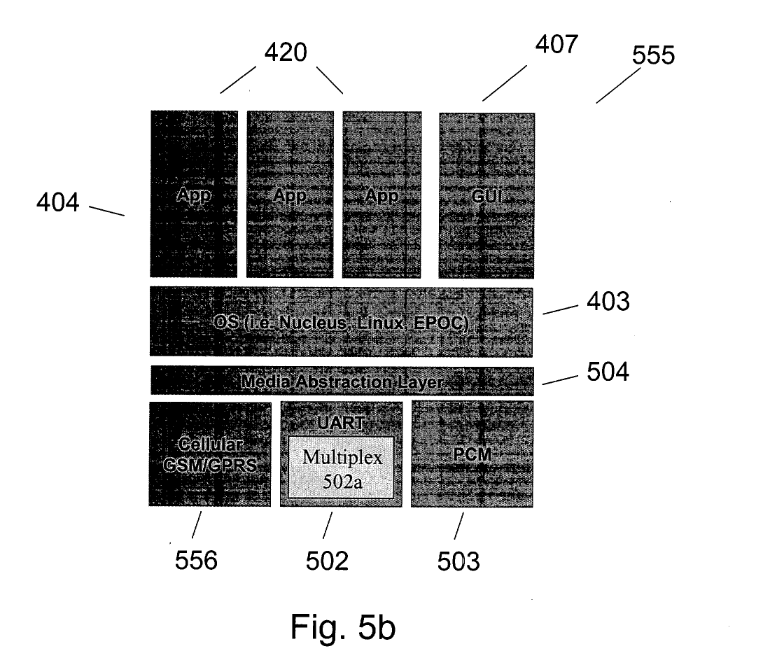

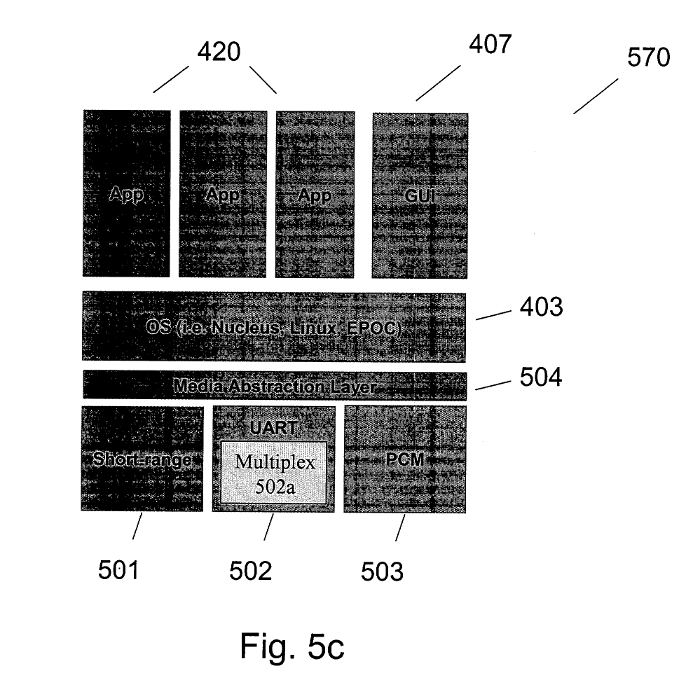

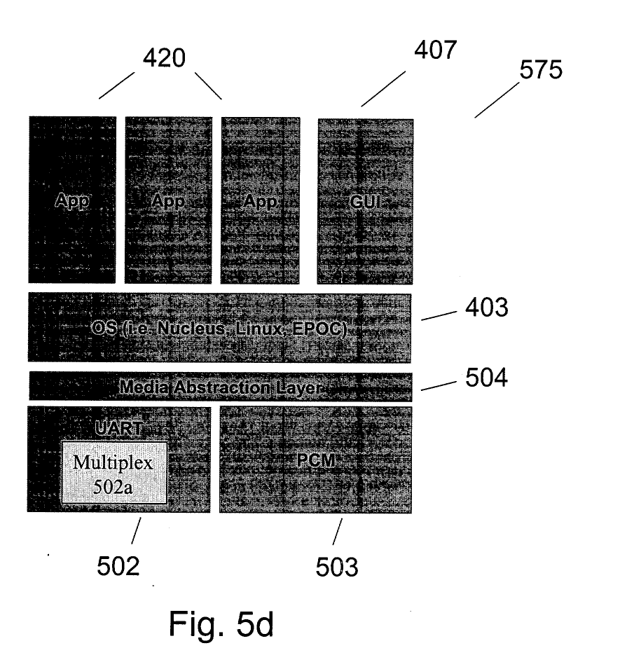

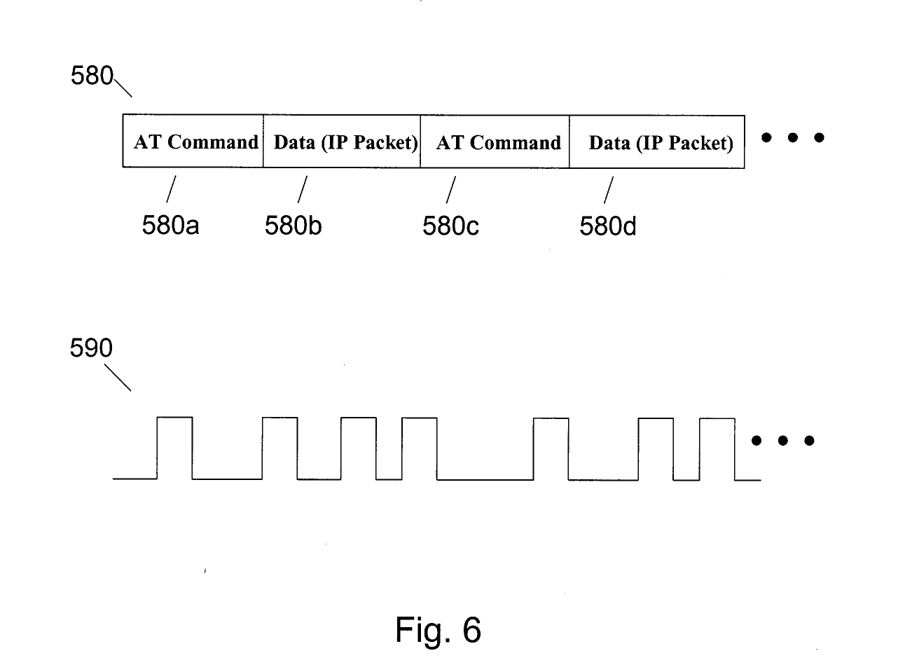

FIGS. 5a-b illustrate software architectures 500 and 555 for device 106 illustrated in FIG. 1 according to an embodiment of the present invention. In an embodiment of the present invention, software 500 is stored in memory 302 and software 555 is stored in memory 332. Software 555 is similar to software 500 except that a microrouter software component 404 is not present and cellular baseband protocol stack software component 556 is stored instead of short-range radio baseband protocol stack software component 501. In an embodiment of the present invention, cellular baseband protocol stack software component 556 translates between GSM/GPRS protocol and AT commands and data packets.

FIGS. 5c-d illustrate software architectures 570 and 575 for terminal 107 in FIG. 2 according to an embodiment of the present invention. In an embodiment of the present invention, software 570 is stored in memory 393 and software 575 is stored in memory 382. Software 570 includes short-range radio baseband protocol stack software component 501. In contrast, software 575 does not include a short-range radio baseband protocol software component. Both software 570 and 575 includes UART software component 502 and PCM software components 503. Like reference numerals in FIGS. 5a-d refer to like software components described above

In an embodiment of the present invention, software components referenced in FIGS. 5a-d, 7 and 8 represent a software program, a software object, a software function, a software subroutine, a software method, a software instance, and a code fragment, singly or in combination. In an alternate embodiment, functions performed by software components illustrated in FIGS. 5a-d, 7 and 8 are carried out completely or partially by hardware.

In an embodiment of the present invention, software 500, 555, 570 and 575 or components of software 500, 555, 570 and 575 are stored in an article of manufacture, such as a computer readable medium. For example, software 500 is stored in a magnetic hard disk, an optical disk, a floppy disk, Compact Disk Read-Only Memory (“CD-ROM”), RAM, ROM, or other readable or writeable data storage technologies, singly or in combination. In yet another embodiment, software 500, 555, 570 and 575 or components thereof, are downloaded from manager server 102 illustrated in FIG. 3.

Software 500 includes physical layer protocol stacks, in particular Bluetooth™ or short-range radio baseband protocol stack software component 501, UART software component 502, including multiplexing software component 502a, and PCM software component 503. In an embodiment, short-range radio baseband protocol stack software component 501 is used with processor 301 to transmit and receive short-range radio signals. UART software component 502, including multiplexing software component 502a, is used by processors 301 and 331 to transfer AT commands and data on bus 321. PCM software component 503 is used by processors 301 and 331 to transfer analog signals on bus 320.

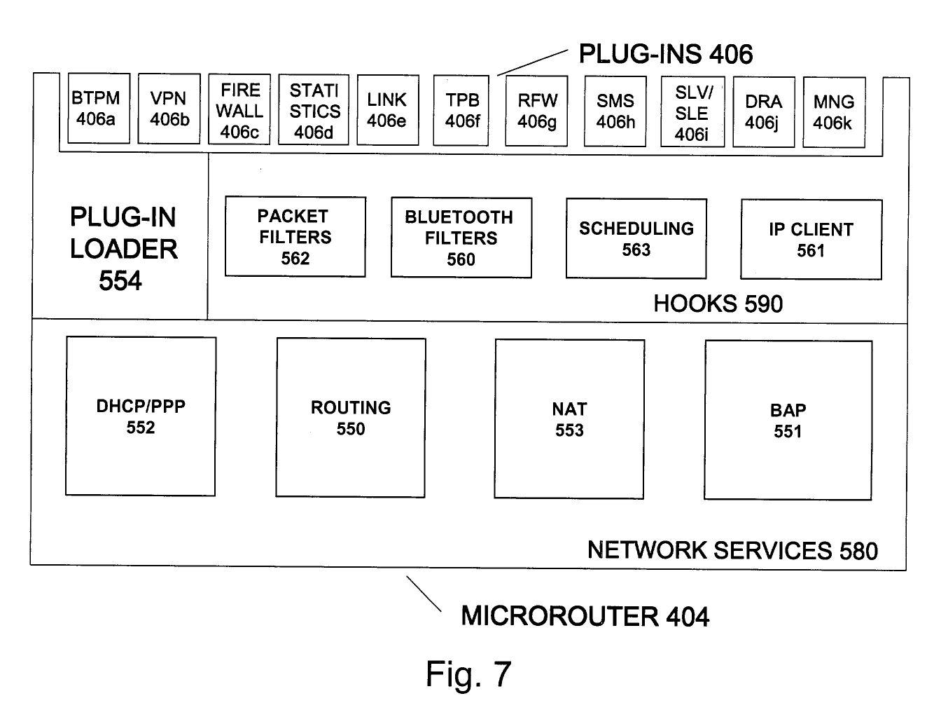

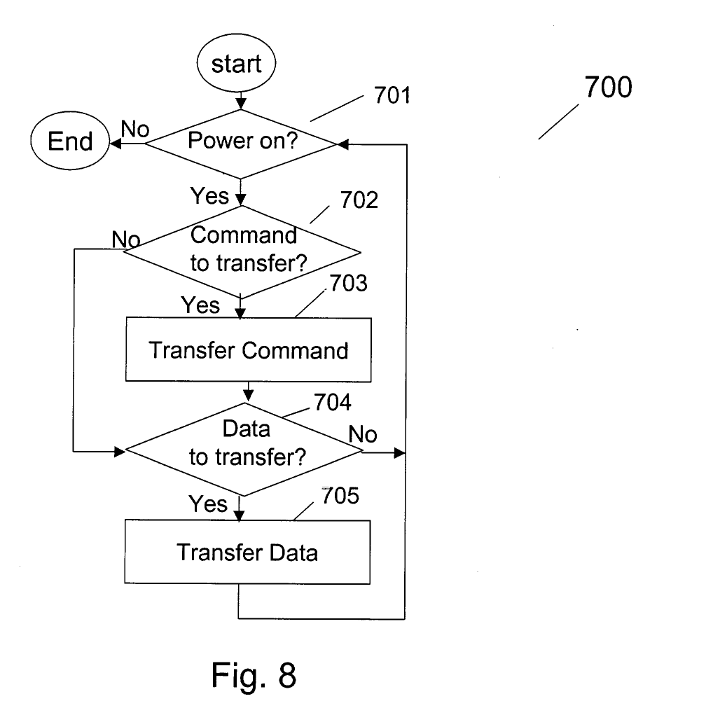

UART software component 502 includes a multiplexing software component 502a for transferring multiplexed AT commands and data on bus 321. FIG. 8 illustrates a method 700 for transferring multiplexed AT commands and data according to an embodiment of the present invention. In an embodiment, a method 700 is performed, in part or completely, by software components illustrated in FIGS. 5 and 7. In an embodiment of the present invention, a logic block or step illustrated in FIG. 8 may represent an execution of a software component, such as a software program, a software object, a software function, a software subroutine, a software method, a software instance, a code fragment, singly or in combination. In an alternate embodiment of the present invention, a logic box or step represents execution of a software component, hardware operation or user operation, singly or in combination. In an alternate embodiment of the present invention, fewer or more logic boxes or steps are carried out in the method illustrated in FIG. 8.

Method 700 initiates at logic block 701 where a determination is made whether power is provided. In an embodiment of the present invention, a determination is made whether device 106 or terminal 107 is powered on. If power is turned on, control passes to logic block 702; otherwise, method 700 ends. A determination is made whether an AT command is queued for transfer in logic block 702. If an AT command is not available for transfer, control transfers to logic block 704. Otherwise, an AT command is transferred on a bus, such as bus 321, in logic block 703. A determination is made whether data is queued for transfer in logic block 704. If data is not available, control transfers to logic block 701 where the previous steps may be repeated. Otherwise, control passes to logic block 705 where data is transferred on a bus, such as bus 321. Control is then passed to logic block 701 where the previous steps may be repeated.

In an embodiment of the present invention, operating system (“OS”) 403 is used to communicate with software components 501-503 and 556. In an embodiment of the present invention, operating system 403 is a Linux operating system, EPOC operating system available from Symbian software of London, United Kingdom, a PocketPC or Stinger operating system available from Microsofto Corporation of Redmond, Wash., or a Nucleus operating system, available from Accelerated Technology, Inc. of Mobile, Ala. Operating system 403 manages hardware and enables execution space for device software components.

Media abstraction layer 504 allows operating system 403 to communicate with software components 501-503 and 556, respectively. Media abstraction layer 504 and other abstraction layers, described herein, translate a particular communication protocol, such as Bluetooth™, into a standard command set used by a device and/or terminal. The purpose of an abstraction layer is to isolate the physical stacks from the rest of the device software components. This enables future usage of different physical stacks without changing any of the upper layer software and allows the device software to work with any communication protocol.

Furthermore, Graphics User Interface software component (“GUI”) 407 is provided to allow a user-friendly interface.

Application software components 420, such as a calendar software component or messaging software component, provide applications or services to users.

Microrouter software component 404 and network plug-ins 406 enable an IP based network between device 106 and terminals 107 and enhances an IP based network, respectively. In an embodiment of the present invention, each terminal can leverage the existing IP protocol, exchange information with other terminals and gain access to a WAN through microrouter 404. Extended network services, such as network service plug-ins 406, may be added to microrouter 404. In an embodiment, manager server 102, installs microrouter 404 and network service plug-ins 406 on device 106.

FIG. 7 illustrates software components of microrouter 404. In an embodiment of the present invention, routing component 550, Bluetooth™ LAN Access Profile component 551, Point-to-Point Protocol (“PPP”) component 552 and Network Address Translator (“NAT”) component 553 are included in microrouter 404. In an alternate embodiment, other components, such as packet filters 562, Bluetooth™ filters 560, scheduling 563 and IP client 561 are included in microrouter 404. In still another embodiment, microrouter 404 includes hooks 590 for adding network services plug-ins 406.

In an embodiment, microrouter 404 services include software components for a short distance wireless network that has access to a WAN. In an embodiment, the software components included in a microrouter 404 are described below.

BAP software component 551 enables Bluetooth™ terminals to gain access to short distance wireless network 116 and a WAN by using an IP protocol.

In an embodiment of the present invention, BAP 551 includes implementation of two Bluetooth™ usage profiles such as: 1) Bluetooth™ LAN Access Profile software and 2) Bluetooth™ Dial-Up Profile software.

Bluetooth™ LAN Access Profile software component allows a LAN Access client in a terminal to obtain an IP address and use the IP address in order to gain connectivity to other short distance wireless network terminals or to a WAN, behaving as if they were on a short distance wireless network. Bluetooth™ Dial-Up Profile software component enables a terminal to dial-up to any termination number and get IP services from that termination. In addition, a Bluetooth™ Dial-Up Profile (“DUP”) software component emulates termination in device 106. In an embodiment, microrouter 404 has either a Bluetooth™ LAN Access Profile software component or a Bluetooth™ Dial-Up Profile software component. In an alternate embodiment, microrouter 404 includes both Profile software components. In a Bluetooth™ Dial-Up Profile software component mode, a terminal dials a predefined number, for example 999, for which microrouter 404 will not actually dial the number over a cellular network, but emulates as if the number was dialed and a modem answered the call. Microrouter 404 will provide the terminal with an IP address and access to WAN 105. From the terminal's point of view it is as if the terminal dialed a number 999 to a modem and received an IP service from that modem, but in reality the terminal used DUP to obtain packet switching access to WAN 105 and the call was actually terminated at microrouter 404.

Routing software component 550 is responsible for transferring IP packets either in a short distance wireless network or toward a WAN. In an embodiment of the present invention, routing software 550 translates between short-range radio protocol messages and AT commands and data packets. In a short distance wireless network 116, Routing software component 550 handles broadcasting IP packets and transferring IP packets between terminals. Routing software component 550 is also responsible for LAN IP Broadcast emulation.

Routing software component 550 is responsible for IP packet queuing/dropping. An IP packet dropping software component is used for reducing congestion caused by having more than one terminal connected simultaneously. In an embodiment of the present invention, Routing software component 550 includes a queuing software component, Quality of Service software component or equivalent for queuing IP packets. Likewise, Routing software component 550 includes a dropping software component that is configured by manager server 102, a user or any other remote entity. In an embodiment of the present invention, manager server 102 defines and loads an IP packet queuing/dropping software component. An operator will be able to define a particular queuing/dropping software component that is suitable for a particular short distance wireless network 116 or user. A user will have a better short distance wireless network 116, and thus a better user experience, without having to configure or monitor a short distance wireless network 116.

In an alternate embodiment of the present invention, Routing software component 550 is a bridge software component for transferring an IP address.

In an embodiment of the present invention, microrouter 404 includes a PPP software component 552, such as a PPP server that is the termination for a short distance wireless network access profile software component. A PPP server provides IP network information, such as an IP address, DNS address or the like, to a terminal.

NAT software component 553 is used because 1) only one public IP address is typically made available to a device 106 and 2) in order to conserve public IP addresses provided by an operator. In an embodiment of the present invention, WAN 105, and in particular, a cellular packet switching network 129 provides device 106 with one public IP address. A short distance wireless network 116, however, includes more than one participating terminal. In order to provide IP addresses to all terminals 107, private short distance wireless network IP addresses will be used for terminals 107 while NAT 553 is responsible for translations between private short distance wireless network IP addresses and public WAN addresses, and vice versa.

In an embodiment of the present invention, microrouter 404 includes hooks 590 allowing for the extension of microrouter 404 networking services, such as plug-ins 406. In an embodiment of the present invention, hooks 590 are application program interfaces (“API”) for plug-ins 406.

In an embodiment of the present invention, microrouter 404 is programmed to have only basic network abilities and a very low footprint; or in other words require very little memory, for example 100K bytes, in order to be stored in a device 106, such as a cellular telephone. However, in some instances, more network services will be needed. Further, operators may want the ability to add and sell network services after the device 106 is sold and in operation without user intervention. A user may be less likely to purchase a network service if the user has to return device 106 to the manufacturer or an inconvenient site.

For these and other reasons, the microrouter 404 includes hooks 590 that enable plug-ins 406 to be implemented in an embodiment of the present invention. This plug-in capability does not define a full execution environment but defines a small framework for implementing code, which can plug-in and extend microrouter 404 network services. In an embodiment of the present invention, hooks 590 are not a user application framework, plug-in code abilities are limited and serve only as an extension to network services.

Plug-ins 406 are fully activated by microrouter 404, which has full control over them in an embodiment of the present invention. In some sense, plug-ins are like a Dynamic Link Library (“DLL”) that have a predetermined set of functions that a microrouter can call in order for them to realize the needed functionality.

Below describes software components included in hooks 590 for implementing plug-ins 406 according to an embodiment of the present invention. In an alternate embodiment, other software components are included or replace illustrated software components in hooks 590. For example, software components implementing functionality used by all plug-ins 406, such as hooks for centralized configuration and backend connectivity, are included in hooks 590 in an embodiment of the present invention. These included software components in hooks 590 will save resources and allow for efficient operation.

Packet filters software component 562 allows plug-ins 406 to process IP packets going either internally in a short distance wireless network 116, or externally to and from a WAN. By enabling plug-ins 406 to process IP packets, change any part of a packet, drop a packet or generate more packets, microrouter 404 is able to include multiple other added extended network services. For example, microrouter 404 is able to include a VPN, a firewall, tag packets, monitor packets and other extended network services described below. In an embodiment of the present invention, packet filters 562 is a data path for transferring IP packets that are accessible by plug-ins 406.

Bluetooth™ filters software component 560 enables plug-ins 406 to process Bluetooth™ information. In an embodiment, Bluetooth™ filters 560 processes a pairing request event and provides a PIN number. In an embodiment of the present invention, Bluetooth™ filters 560 enables added network services such as PIN management, denying access to a short distance wireless network 116 from a terminal, authenticating a terminal, pairing through an interactive voice response (“IVR”) system or the Internet. In an embodiment of the present invention, a Bluetooth™ filters 560 is a data path for transferring Bluetooth™ information that is accessible by plug-ins 406.

In order for plug-ins 406 to be able to generate events, traffic or do periodic tasks, a scheduling software component 563 enables a plug-in to receive a callback periodically or when required by the plug-in. For example, Scheduling software component 563 enables a statistics plug-in to send statistic information on terminal and application usage every X hours, or calculate average traffic at a selected terminal.

In an embodiment of the present invention, IP Client software component 561 makes available IP services to plug-ins 406 so a plug-in can obtain an IP address, send IP packets and/or receive IP packets. Thus, IP Client software component 561 enables a plug-in to obtain a private IP address from microrouter 404 and connect to a backend server, such as manager server 102. An IP client 561 can implement a TCP/IP stack or User Datagram Protocol (“UDP”). In an embodiment of the present invention, IP Client plug-in 561 uses all necessary microrouter 404 network services, such as packet filters 562 or NAT 553. From a microrouter 404 perspective, an IP Client 561 is treated like any other terminal on a short distance wireless network 116.

A plug-in can be attached to a microrouter 404 during or after manufacturing. In an embodiment of the present invention, a plug-in is stored or programmed in device 106 before shipping from a manufacturer. Alternately, a plug-in is downloaded from manager server 102 at run-time over WAN 105.

Below describes microrouter 404 extended service plug-ins 406 in an embodiment of the present invention. In various embodiments of the present invention, one or more of plug-ins 406 are attached to microrouter 404. In alternate embodiments, other plug-ins are attached to microrouter 404. In an embodiment of the present invention, a device manufacturer, a terminal manufacturer, an operator and/or another third party provides a plug-in.

BTPM software component plug-in 406a is responsible for PIN management and authenticating terminals for participating in a short distance wireless network 116. BTPM 406a allows an operator to control which terminal can connect to a short distance wireless network 116. For example, an operator 115 can deny a terminal from pairing to a short distance wireless network 116, or can approve a terminal for pairing. In an embodiment of the present invention, pairing is done over an IVR, the Internet and/or by a user.

VPN software component plug-in 406b enables a secure link to a network, such as a private corporate network. VPN enables terminals to connect to a corporate file server, exchange server or an equivalent. VPN 406b uses packet filters 562 in order to identify packets that are routed to a corporate LAN IP subnet. In an embodiment of the present invention, VPN 406b then encrypts and tunnels the identified IP packets.

Firewall software component plug-in 406c protects a short distance wireless network 116 from intruders and hackers. In an embodiment of the present invention, Firewall 406c uses packet filters 562 for identifying IP packets from non-authorized sources and IP packets that are sent to non-authorized servers. In an embodiment of the present invention, Firewall 406c enables Uniform Resource Locator (“URL”) filtering.

In an embodiment of the present invention, Statistics software component plug-in 406d collects usage profiles and statistics on 1) which terminal in a short distance wireless network 116 is used, 2) how much traffic is generated by each terminal, and 3) how much traffic is generated by each application. Statistics 406d enables an operator to promote used terminals and build billing schemes.

Implementing direct TCP/IP and Internet application protocols over WAN 105, and in particular a wireless network, produces poor performance because of low bandwidth, transmission delays and high data error rates. In order to solve the poor performance, but still enable terminals to use standard TCP/IP, a Link Optimization software component plug-in 406e is provided. Link Optimization 406e traps all TCP/IP and specific Internet application protocols, such as Simple Mail Transfer Protocol (“SMTP”) and Hypertext Transfer Protocol (“HTTP”), and converts the protocol to an optimized protocol. Link Optimization 406e then sends the converted packets to a backend server, such as manager server 102, which then deconverts the packets and sends them onto the Internet. In an embodiment of the present invention, terminals and users are not aware of using Link Optimization 406e.

As opposed to a typical LAN firewall that protects a short distance wireless network 116 from intruders and hackers from the Internet or another network, a Reverse Firewall (“RFW”) software component plug-in 406g protects an operator or another network from terminals and applications on a short distance wireless network 116 generating traffic toward those networks. RFW 406g enables an operator or another entity to define and enforce usage policies for applications/terminals on a short distance wireless network 116. RFW 406g prevents unnecessary costly transmission costs. Enforcement of usage policies at the short distance wireless network level (i.e. at device 106) prevents expensive packets from going through a cellular network that will be eventually dropped. Further, packets that may be later dropped do not use the limited cellular transmission bandwidth.

In an embodiment of the present invention, RFW 406g is attached to a cellular handset that has Bluetooth™ capability for implementing a short distance wireless network 116 and GSM/GPRS for cellular access to a WAN 105 (i.e. Internet or any other network). RFW 406g is programmed to drop packets based on the originating terminal, originating application/terminal pair or original application. For example, if a user has a PDA and a Notebook, an operator can configure for File Transfer Protocol (“FTP”) packets from the PDA to be dropped if FTP from a PDA is not allowed, or for example to drop video streaming packets originated from the Notebook if video streaming is something the operator does not allow.

Another example includes blocking Notebook usage of such software as Napster in order to avoid cellular unintended usage by users and associated cost.

TPB software component plug-in 406f enables the programming of terminals 107 over Bluetooth™ and over a cellular network. In an embodiment of the present invention, programming a terminal is accomplished by “flashing” or programming EEPROM memory in a terminal. An operator or manufacturer can transfer a flash image to be flashed to device 106 having microrouter 404, and terminals 107 to be flashed. TPB 406f communicates with a Flashing software component in a terminal to 1) initiate the flashing process, 2) authenticate the flash image and 3) secure the flashing process.

In an embodiment of the present invention, flashing is done by transferring a full flash image. Alternatively, if there is not enough memory for the full flash image in device 106, the flash image is transferred block by block to eventually be flashed.

TPB 406f enables customizing a terminal, fixing software running on a terminal, and adding applications and/or improvements.

SMS software component plug-in 406h allows terminals 107 to send messages between each other in a short distance wireless network 116. In an embodiment of the present invention, a terminal is a Messaging Terminal that enables Instant Messaging over IP. In an alternate embodiment of the present invention, SMS 406h enables standard legacy SMS or Instant Messaging over SMS.

In an embodiment of the present invention, SMS 406h is an SMS server for terminals 107 and an SMS termination for device 106. In this way, a protocol will be defined that enables each terminal to send a packet to SMS 406h with a destination device phone number+message text. SMS 406h then sends the SMS message to a cellular network 129.

SMS 406h also serves as an SMS receiver in an embodiment of the present invention. A terminal can inquire SMS 406h for received SMS messages and fetch those messages. In still another embodiment of the present invention, a terminal will also receive an IP broadcast message each time an SMS message is received by device 106.

SLV/SLE software component plug-in 406i enables an operator to verify and enforce service level agreements with users. If an operator wants to enforce service levels, such as specifically limiting the amount of traffic over a cellular network, SLV/SLE 406i is added in order to avoid usage of expensive airtime.

In an embodiment of the present invention, SLV/SLE 406i allows a user to generate an unlimited amount of cellular traffic from device 106 during the night but a limited amount during the day. So during the day, if the limited amount is exceeded, no more traffic can be generated from device 106 and packets are dropped by SLV/SLE 406i. Similar policies may likewise be enforced. SLV/SLE 406i also identifies and notifies the operator of missed cellular network usage by a particular user due to enforcement in an embodiment of the present invention.

DRA software component plug-in 406j enables terminals to gain access (according to defined restrictions) to device 106 resources. This enables a terminal to implement a Device Resources Access protocol over IP in order to gain access to any of the following resources: 1) phone book, 2) play a ring tone, 3) initiate a call, 4) user interface, or 5) other device resources. DRA 406j enables a terminal to read/modify/add phone book entries in a phone book stored on device 106. In a preferred embodiment, a vCard format is used to exchange entry information between device 106 and terminals 107. This enables a more consistent experience for users. For example, DRA 406j provides a user immediate access to device 106 phone book entries for sending a message from a messaging terminal without having to type the contact information from the phone book.

DRA 406j enables a user to be alerted by using a device 106 ring buzzer. Thus, a terminal in short distance wireless network 116 can use a device 106 ring buzzer for alerting a user.

DRA 406j enables a terminal, such as a PDA or an Outlook application on a notebook computer, to initiate a telephone call at device 106. In an embodiment of the present invention, clicking a phone icon near a phone number on a notebook display initiates a cellular telephone call.

Likewise, DRA 406j enables a terminal to interact with a user through device 106 menus and input components.

MNG software component plug-in 406k enables management, configuration and monitoring of terminals 107 in an embodiment of the present invention. Instead of each terminal implementing a proprietary management protocol and console, each terminal exposes a “registry” of parameters and MNG 406k implements a protocol enabling a managing server 102 to browse this registry, get values and set values.

In summary of operation of dual bus device 106, short-range radio signals 110 are received and may cause cellular signals 111 to be generated. Likewise, cellular signals 111 are received and may cause short-range radio signals 110 to be generated to a terminal 107 in an embodiment of the present invention. For example, a user of PDA 107b selects a URL address of a web site. PDA 107b then generates a short-range radio signal requesting the contents at the selected web site. Antenna 308, receiver 309 and short-range RF circuit 337 translates the short-range radio signal and puts the request on bus 306.

Routing software component 550 then translates the short-range protocol message or Bluetooth™ protocol request to an AT command and data. Processor 301 then generates, by way of UART software component 502, and in particular multiplexing software 502a, multiplexed AT commands and data on bus 385. A UART software component in processor 384 receives the commands and transfers the command and data to cellular protocol 333 that generates the appropriate signals on bus 336 to cellular RF circuit 337, transmitter 339 and antenna 338. Cellular signals 111 containing a request for the web site are then generated to cellular network 129 and eventually Internet 103.

Voice from a headset 107c is similarly transferred from device 106 to WAN 105, except voice is transferred and received on bus 386 by PCM software component 503 in processors 387 and 384. Likewise, voice may be received and transferred to a terminal 107.

Contents of the selected web site are then transferred over cellular network 126 in cellular signals 111 to antenna 338, receiver 330 and cellular RF circuit 337 in device 106. In response to signals on bus 336, software 555, and in particular cellular baseband protocol stack 556, translates the contents of the web site and passes AT commands and data to a UART software component in processor 331. AT commands and data are then multiplexed on bus 321 to App processor 301. Routing software component 550 then translates the web site contents in the form of AT commands and data to a short-range radio command on bus 306 to short-range RF circuit 307 which, along with transmitter 311 and antenna 308 generate the contents of the web site to the display of PDA 107b.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1) A device, comprising:
a first bus;
a first transceiver, coupled to the first bus, capable to transmit and receive a cellular signal responsive to a first control signal;
a first processor, coupled to the first bus, capable to generate the first control signal;
a second bus;
a second transceiver, coupled to the second bus, capable to transmit and receive short-range radio signal responsive to a second control signal;
a second processor, coupled to the second bus, capable to generate a second control signal; and,
a third bus coupled between the first processor and second processor.

2) The device of claim 1, wherein the third bus includes a universal a synchronous receiver-transmitter (“UART”) bus.

3) The device of claim 2, wherein the UART bus transfers an AT command and a data packet, wherein the AT command and data packet are multiplexed on the UART bus.

4) The device of claim 1, wherein the third bus includes a pulse code modulation (“PCM”) bus.

5) The device of claim 4, wherein the PCM bus transfers voice.

6) The device of claim 1, wherein the device is a handheld device.

7) The device of claim 1, wherein the device is a cellular telephone.

8) The device of claim 3, wherein the data packet is an Internet protocol (“IP”) packet.

9) The device of claim 1, wherein the cellular signal includes an IP packet and the short-range radio signal includes an IP packet.

10) The device of claim 1, further comprising:
a first memory device coupled to the first bus; and,
a second memory device coupled to the second bus.

11) The device of claim 10, wherein the first and second memory devices are selected from the group consisting of static random access memory (“SRAM”), synchronous dynamic random access memory (“SDRAM”), dynamic random access memory (“DRAM”) and an equivalent thereof.

12) The device of claim 10, further comprising:
a third memory device coupled to the first bus; and,
a fourth memory device coupled to the second bus.

13) The device of claim 12, wherein the third and fourth memory device includes a memory device selected from the group consisting of FLASH or electrically erasable programmable read-only memory (“EEPROM”), electrically programmable read-only memory (“EPROM”) and read-only memory (“ROM”).

14) The device of claim 12, wherein the first memory device and third memory devices are included on a first integrated circuit formed on a first semiconductor substrate, and the second and fourth memory devices are included on a second integrated circuit formed on a second semiconductor substrate.

15) The device of claim 12, wherein the fourth memory includes a router software component to transfer a packet between a short-range radio network and a wide area network (“WAN”).

16) The device of claim 15, wherein the fourth memory further includes an application software component to provide a service to the short-range radio network.

17) The device of claim 1, wherein the second processor is a short-range radio processor and the second transceiver is a 2.4 GHZ transceiver.

18) The device of claim 1, wherein the second processor is a short-range radio processor and the second transceiver is a 5.7 GHZ transceiver.

19) The device of claim 15, wherein the short distance wireless network is a Bluetooth™ wireless local area network.

20) The device of claim 15, wherein the short distance wireless network is an 802.11 wireless local area network.

21) The device of claim 1, wherein the first transceiver uses a protocol selected from the group consisting of Global System for Mobile communications (“GSM”), Code Division Multiple Access (“CDMA”) CDMA2000, Universal Mobile Telecommunications System (“UMTS”) and Time Division Multiple Access (“TDMA”) protocol.

22) The device of claim 1, wherein the first transceiver uses a GSM 07.10 Multiplexing protocol.

23) A handheld device, comprising:
a first bus;
a first transceiver, coupled to the first bus, capable to transmit and receive a cellular signal responsive to a first control signal;
a first processor, coupled to the first bus, capable to generate the first control signal;
a first memory, coupled to the first bus, capable to store a cellular software component to generate the cellular signal using a predetermined cellular protocol;
a second bus;
a second transceiver, coupled to the second bus, capable to transmit and receive short-range radio signal responsive to a second control signal;
a second processor, coupled to the second bus, capable to generate a second control signal;
a second memory, coupled to the second bus, capable to store a router software component to transfer a packet;
a UART bus, coupled between the first processor and the second processor, to transfer an AT command and data packet; and, a PCM bus, coupled between the first processor and the second processor, to transfer voice.

24) The device of claim 23, wherein the first transceiver uses a GSM 07.10 Multiplexing protocol.

25) The handheld device of claim 23, wherein the first and second memory device includes a memory device selected from the group consisting of FLASH or electrically erasable programmable read-only memory (“EEPROM”), electrically programmable read-only memory (“EPROM”) and read-only memory (“ROM”).

26) The handheld device of claim 23, further comprising:
a third memory coupled to the first bus; and,
a fourth memory coupled to the second bus.

27) The handheld device of claim 26, wherein the third and fourth memory is a memory device selected from the group consisting of static random access memory (“SRAM”), synchronous dynamic random access memory (“SDRAM”), dynamic random access memory (“DRAM”) and an equivalent thereof.

28) A device, comprising:
a first bus;
a first transceiver, coupled to the first bus, capable to transmit and receive a cellular signal responsive to a first control signal;
a first processor, coupled to the first bus, capable to generate the first control signal;
a second bus;
a second transceiver, coupled to the second bus, capable to transmit and receive short-range radio signal responsive to a second control signal;
a second processor, coupled to the second bus, capable to generate a second control signal, wherein the second processor includes a first memory storing a router software component; and,
a third bus coupled between the first processor and second processor, wherein the first processor generates consecutively a first AT command, data, and a second AT command on the third bus to the second processor.

29) The device of claim 28, wherein the first transceiver uses a GSM 07.10 Multiplexing protocol.

30) The device of claim 28, wherein the first processor includes a first memory storing a cellular software component.

31) The device of claim 28, further comprising a second memory coupled to the first bus.

32) The device of claim 28, wherein the second processor includes a second memory.

33) The device of claim 31, wherein the second memory is a memory device selected from the group consisting of static random access memory (“SRAM”), synchronous dynamic random access memory (“SDRAM”), dynamic random access memory (“DRAM”) and an equivalent thereof.

34) The device of claim 28, wherein first memory includes a memory device selected from the group consisting of FLASH or electrically erasable programmable read-only memory (“EEPROM”), electrically programmable read-only memory (“EPROM”) and read-only memory (“ROM”).

35) The device of claim 28, wherein the second processor is an integrated circuit formed on a semiconductor substrate having a package.

36) A device, comprising:
a first bus;
a first processor having a memory device storing an application-software component, coupled to the first bus;
a second bus;
a first transceiver, coupled to the second bus, capable to transmit and receive short-range radio signal responsive to a first control signal;
a second processor, coupled to the second bus, capable to generate the first control signal; and,
a third bus coupled between the first processor and second processor, wherein the first processor generates consecutively a first AT command, data, and a second AT command on the third bus to the second processor.
